(19) United States
(12) Patent Application Publication
(10) Pub. No.: US 2017/0277834 A1
(43) Pub. Date: Sep. 28, 2017

(54) MEDICAL SERVICES APPROVAL AND REWARDS SYSTEM AND METHOD OF USE

(71) Applicant: Approve Care, LLC, Park City, UT (US)

(72) Inventors: Richard Zipnick, Park City, UT (US); Zachary Zipnick, Park City, UT (US)

(21) Appl. No.: 15/382,215

(22) Filed: Dec. 16, 2016

Related U.S. Application Data
(60) Provisional application No. 62/243,236, filed on Oct. 19, 2015.

(51) Int. Cl. G06F 19/00

(52) U.S. Cl. CPC G06F 19/322; G06F 19/324

(57) ABSTRACT

A method for medical approval can include: receiving a request to approve a medical device or service; obtaining at least three data sets from: patient data; payer requirement data; provider data; vendor data; device data; device contracted price data; device actual price data; and facility data for a facility where the provider uses the medical device on the patient; comparing the at least three data sets to determine if the medical device or service matches with the at least three data sets; and determining whether or not the medical device or service is approved, wherein: if the at least three data sets match with the medical device or service, the medical device or service is approved; or if the at least three data sets do not match with the medical device or service, the medical device or service is not approved. The system provides price transparency and healthcare rewards.

### CROSS-REFERENCE

This patent application claims priority to U.S. Provisional Application No. 62/243,236 filed Oct. 19, 2015, which provisional is incorporated herein by specific reference in its entirety.

### BACKGROUND

Electronic medical records are currently available to manage patient data. However, no electronic management system exists to automatically manage medical services data, such as medical procedures and/or medical device selection data, and to determine whether patients meet criteria for receiving medical services and/or devices. Accordingly, there is no system available to immediately match a payer's guidelines and requirements to the patient's co-morbidities to facilitate approval of medical services and/or devices. No system exists to immediately communicate with the surgeon (or other medical professional) or medical facility regarding the requirements of payers for approving performance of medical services or use of medical devices. No system exists to provide transparency of the cost of services and/or devices at the point of care. No system exists to reward or penalize facilities and/or providers for cost savings and outcome of services and/or devices at the point of care. Also, no system exists to determine, approve, and/or modify a surgeon's device preference based on patient data, facility payment, and outcome data.

### SUMMARY

In one embodiment, a method for managing medical device approval can include: receiving a request to approve a medical device; obtaining at least three data sets from the following data sets: patient data for a patient to receive the medical device; payer requirement data for a payer that pays for the medical device; provider data for a provider that uses the medical device on the patient; vendor data for a vendor for the medical device; device data for the medical device; device contracted price data for the medical device; device actual price data for the medical device; and facility data for a facility where the provider uses the medical device on the patient; comparing the at least three data sets to determine if the medical device matches with the at least three data sets; and determining whether or not the medical device is approved, wherein: if the at least three data sets match with the medical device, the medical device is approved; or if the at least three data sets do not match with the medical device, the medical device is not approved.

In one embodiment, a method for managing medical service approval can include: receiving a request to approve a medical service; obtaining at least three data sets from the following data sets: patient data for a patient to receive the medical service; payer requirement data for a payer that pays for the medical service; provider data for a provider that performs the medical service on the patient; service data for the medical service; service price data for the medical service; and facility data for a facility where the provider performs the medical service on the patient; comparing the at least three data sets to determine if the medical service matches with the at least three data sets; and determining whether or not the medical service is approved, wherein: if the at least three data sets match with the medical service, the medical service is approved; or if the at least three data sets do not match with the medical service, the medical service is not approved. When the at least three data sets do not match it can be because only one, two or all three do not match. Any time one data set does not match, then the at least three do not match. All three matching is required in one embodiment for approval, and any one of the three not matching can cause denial. However, there may be instances where only two need to match instead of three for the approval.

In one embodiment, a method of approving a medical service and/or device can include: entering patient data into a medical approval system, the data including one or more medical conditions of a patient; entering medical service data and/or medical device data into the medical approval system; entering payer data into the medical approval system, wherein the payer data includes data related to requirements for the payer to pay for the medical service and/or medical device; requesting approval of the medical service and/or medical device; and receiving, automatically, an approval or denial of the request.

In one embodiment, a method of approving a medical service and/or medical device can include: providing criteria to be met for approval of a medical service and/or medical device; entering data for the criteria; and requesting approval of the medical service and/or medical device, if all of the criteria are satisfied, approval is provided; or if one or more elements of the criteria are not satisfied, denial is provided. In one aspect, if denial is provided criteria related to the denial is provided, then the method can include: entering data for the criteria related to the denial; and requesting approval of the medical service and/or medical device, if all of the criteria are satisfied, approval is provided; or if one or more elements of the criteria are not satisfied, denial is provided.

In one embodiment, a computer system for management of medical approval can include computer-executable instructions stored on a non-transient storage media that when executed cause the computer system to perform one of the methods described herein.

In one embodiment, any of the methods can be performed to account for a reward for the provider, wherein the reward can increase privileges for the provider. Negative rewards are also possible to decrease privileges for the provider. The determination of a privilege can result in updating the provider data by determining a reward for the provider. In one aspect, the reward is determined by: analyzing a financial benefit provided by the provider for performing a procedure and dividing the financial benefit by a cost of the procedure caused by the provider; or analyzing a benefit of a patient outcome in response to a procedure performed by the provider and dividing the benefit of the patient outcome by a cost of the procedure caused by the provider.

In one embodiment, if at least one of the at least three one data sets does not match with the medical device/service, the medical device/service is not approved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 includes a schematic representation of a medical device management approval system.

FIG. 2 includes a schematic representation of a medical service management approval system.

FIG. 3 includes a schematic representation of a medical device approval protocol.

FIG. 4 includes a schematic representation of a medical approval system.

FIG. 5 includes a schematic representation of a computing system that can be used in the medical approval systems.

The components of the figures are arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present invention pertains to a medical computer system having software for the medical computer system to function as a medical service and/or device management system for approval or denial of the service and/or device. The medical computer system can provide for cost effective selection, approval, and amendments for medical services and/or devices to be employed in the performance of medical procedures. In one example, the present invention pertains to an electronic medical device management system and method of use. In one example, the present invention pertains to an electronic medical service management system and method of use.

In one embodiment, the present invention provides an electronic medical device management system having software and being configured to manage medical device selection data, and to determine whether patients meet criteria for the medical devices. In one aspect, the system is configured to match a payer's guidelines (e.g., insurance guidelines) and requirements (e.g., insurance requirements) to the patient's symptoms, physical exam, imaging studies, prior care, outcome, co-morbidities and medical needs in order to facilitate approval of medical devices. In one aspect, the system is configured to communicate with a surgeon or facility regarding the requirements of payers (e.g., insurance) for approving medical device use. In one aspect, the system is configured to determine and modify a surgeon's device preference based on patient data, facility payment (e.g., with or without comparison with payer requirements), and medical outcome data.

In another embodiment, the system provides transparency to the cost of medical devices and services at the point of care. Previously the costs of the medical devices and services is an unknown for lack of transparency. Now, with the ability to get pre-approval for a procedure in a way that allows for access to the budget for the procedure (e.g., amount to be paid by payer under insurance guidelines etc.), there is transparency that allows the patient and/or provider to see the budget, which can allow for improved selections for various procedures to meet the budget. It also allows for the selection of medical devices for the procedure that are within the budget so that there is a profit by performing the procedure with the device. These numerical costs can know be known and may also be discussed with the provider and/or patient for determining the services and devices used in the procedure.

In one embodiment, the present invention provides an electronic medical service management system having software and being configured to manage medical service selection data, and to determine whether patients meet criteria for the medical service. In one aspect, the system is configured to match a payer's guidelines (e.g., insurance guidelines) and requirements (e.g., insurance requirements) to the patient's co-morbidities and medical needs in order to facilitate approval of medical service. In one aspect, the system is configured to communicate with a surgeon or facility regarding the requirements of payers (e.g., insurance) for approving medical services. In one aspect, the system is configured to determine and modify a surgeon's medical service preference based on patient data, facility payment (e.g., with or without comparison with payer requirements), and medical outcome data.

Accordingly, the electronic medical management systems include software that provides for the ability of a medical facility (e.g., hospital, surgical center, medical office, etc.) to manage medical services and/or devices in order to facilitate a payer's approval (e.g., insurance approval) for the prescribed medical services and/or devices in order for the medical facility to provide an approval.

A medical service management system can be used in methods to facilitate healthcare approvals before a service is provided or a device is used. The system compares various types of data, such as patient data, payer data, payer requirement data, payment requirement data, provider data, vendor data, device data, device contracted price data, device actual price data, service data, service provider data, facility service data, and/or facility data. The comparison is then used to determine whether or not the medical service and/or device is approved for use in a medical procedure.

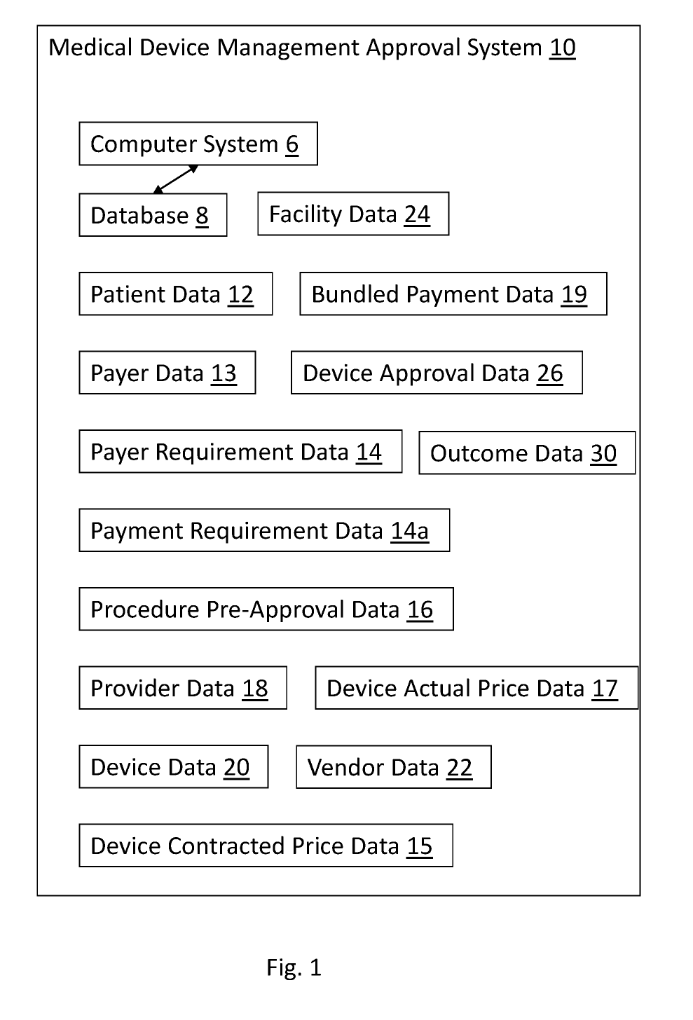

FIG. 1 illustrate a medical device management approval system 10 constructed in accordance with the principles of the invention. The medical device approval system 10 can include a computer system 6 that includes at least one database 8 having the following data elements: patient data 12 that can include information about symptoms, history, physical exam findings, pertinent negatives, prior treatments, outcomes, co-morbidities; payer data 13 that includes information about the person (e.g., patient or patient's parents or guardian) or entity (e.g., insurance company); payer requirement data 14 that can include clinical guidelines that a payer requires for payment; payment requirement data 14a that includes any requirement for payment to be made; procedure pre-approval data 16 that includes the criteria for a medical service and/or medical device to be approved; provider data 18 that can include a device preference of a surgeon and information about the provider, including the number of times the provider has performed a service and the outcomes of the service with relation to medical services and/or medical devices previously used by the provider; device data 20 that can include an FDA approval number, device specifications, and device use indications; vendor data 22 that can include information about a medical device provider, distributor, or manufacturer; device contracted price data 15; device actual price data 17; facility data 24 that includes information related to facility requirements, permissions, or protocols; bundled payment amount data 19 that includes information from a payer to pay for a device or service; for care episodes; and device approval data 26.

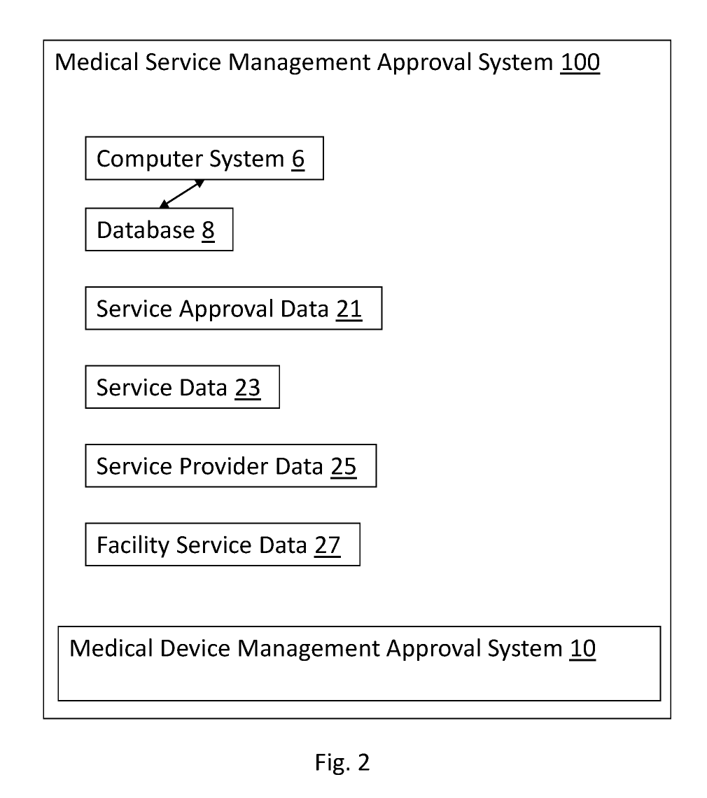

FIG. 2 shows a medical service management system 100 that can include the medical device management system 10, or be operably coupled therewith so that either can operate alone or with the other. In one aspect, both the medical device management system 10 and the medical service management system 100 may operate together to get a medical service that uses a medical device approved. The medical service management system 100 can include a computer system 6 with at least one database 8 having the following data elements: service approval data 21 that includes information about approval of a medical service, such as a medical procedure (e.g., implantation of a first medical device by performing the implantation with a second medical device); service data 23 at includes information about a medical service, such as a protocol to perform a procedure; service provider data 25 including information about the one or more medical professionals (e.g., doctor, surgeon, anesthesiologist, or nurses); and facility service data 27 including information about the facility where the medical services are performed. Facility service data 27 may be the same as facility data 24.

In one embodiment, patient data 12 can include: the patients age; height; weight; demographics; and co-morbidities including, but not limited to: allergies, prior surgery, medical problems, body mass index, medical history, smoking history, alcohol history, medications, physical exam, imaging results, result from prior treatments, re-admission for the same diagnosis (e.g., typically within 1-90 days), etc. The patient data 12 can vary from patient to patient or can vary or be modified over time for each patient, and can be modified when updated by a medical professional or medical facility, such as after a medical service and/or medical device.

In one embodiment, payer data 13 can include any information about the individual or entity that will be paying for the medical service and/or device. The payer can be a parent, guardian, relative, or even the patient. The payer may also be an insurance entity that will be paying for the medical service and/or device.

In one embodiment, payer requirement data 14 can include clinical guidelines that must be met in order for the system to result in a procedure pre-approval. Payer requirements 14 preferably includes, but is not limited to: time and type of conservative treatment, age, body mass index less than 30, no smoking for a certain time period, signs, symptoms, and severity of disease, outcome of prior treatment, etc. Said requirements can vary from payer to payer or can vary over time for each payer, and can be modified.

In one embodiment, the device contract price data 15 can include the data related to a contract and price for the device, and any tiered prices for device between the device vendor and any medical provider or facility.

In one embodiment, the device actual price data 17 can include the data related to an actual price for the device, such as through discounts, bulk orders, or other incentives. In some instances, a device is not under contract and a retail or wholesale price is an actual price. In other instances, the actual price is greater than the contracted price.

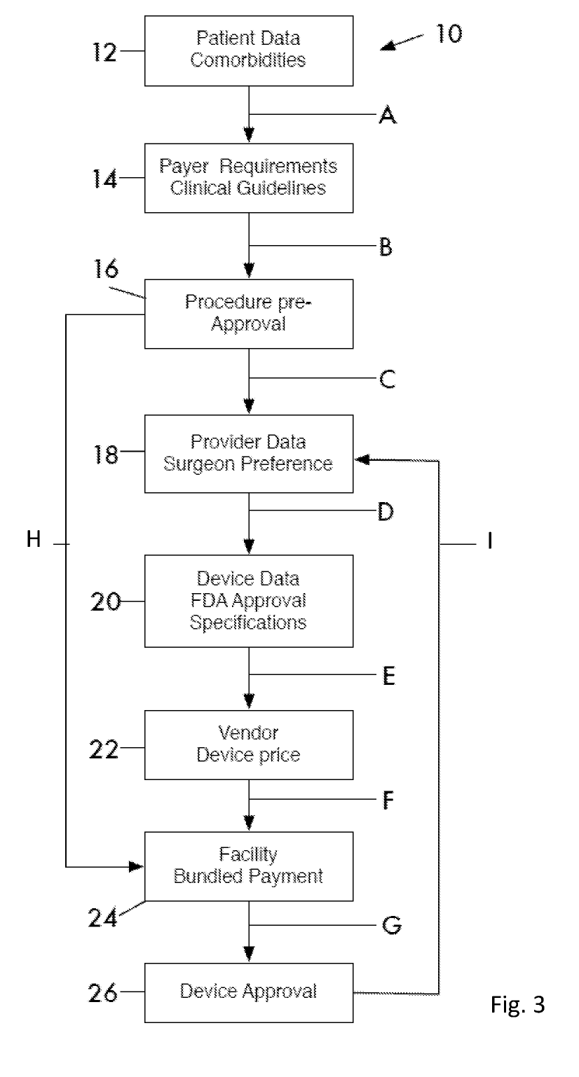

In one embodiment, the procedure pre-approval data 16 is any data that is obtained or used when comparing and matching patient data 12 with payer requirement data 16. As an example but not limitation, if a patient has a body mass index greater than 30, the payer will not pre-approve the medical procedure (e.g., medical service) or medical device used in the procedure. On the other hand, if a patient has a body mass index less than 30, the payer will pre-approve the procedure and use of the device. The procedure pre-approval data 16 can include thresholds that determine when a service/device is or isn't paid under a pre-approval. In one embodiment of FIG. 3, patient data 12 is compared to payer requirement data 14 via arrow A in order to obtain procedure pre-approval data 16 via arrow B.

In one embodiment, provider data 18 can include information about the procedures and devices that a physician or surgeon uses, and any device preference they may have. The provider data 18 can be updated and can vary over time. In one aspect, the systems and methods can use the provider data 18 during approval of a service and/or device. The system as shown in FIG. 3 can be operated to approve the providers preference for a service/device if: (1) patient data 12 and payer requirement data 14 match or are properly correlated, such as via arrows A, B, and C; (2) patient data 12 and device data 20 match, such as via arrows A, B, C, and D; (3) facility data 24 (e.g., including the amount to be paid or reimbursed to the facility from the payer) is greater than or equal to the contracted device price (e.g., device contracted price data 15) or actual device price (e.g., device actual price data 17) from the vendor (e.g., vendor data 22) to return an approval (e.g., device approval data 26), such as via arrows A, B, C, D, E, F, G, and H.

Otherwise if: (1) patient data 12 and payer requirement data 14 do not match, or, (2) patient data 12 and device data 20 do not match or, (3) facility data 24, (including the amount to be paid or reimbursed to the facility from the payer) is less than the contracted or actual device price, the system does not return an approval (e.g., approval denied).

In one embodiment, the bundled payment amount data 19 can include data regarding any agreed or contracted or actual costs that are bundled for payment from the payer to the facility and/or provider for any and all episodes of care. Bundled payment can be for bundled devices, and/or bundled services and devices. Payment can also comprise rewards or penalties for cost savings or lack thereof and or outcomes paid to the facility or the provider.

In one embodiment, device data 20 can include any data regarding the device, and may include FDA recommendations including, but not limited to: system type, product code, indication for use, class, classification identification, 510K approval number, etc.

In one embodiment, vendor data 22 can be any information about the vendor that provides the medical device. A subset of the vendor data 22 can be obtained from the device contracted price data 15 and device actual price data 17, which compares a device with a contracted price to the same or a different device with an actual price and determines the difference and compare said difference to the facility data 24 to return an approval, such as shown in FIG. 3 by arrows F and G.

In one embodiment, the facility data 24 can include any information about the facility where the medical service and/or device is performed/used. It may also include information about bundled payments and amounts for care improvement to be paid to the facility by the payer as shown by arrow H of FIG. 3. If the device actual price is less than or equal to the device contracted price or, if the device actual price is less than the amount allocated for the device from the bundled payment, the system will return an approval, shown by arrows F and G of FIG. 3, and can populate the providers data 18 (e.g., electronic preference card) with an approved device as shown by arrow I. Likewise, if the device actual price is greater than the device contracted price or, if the device actual price is greater than the amount allocated for the device from the bundled payment, the system will not return an approval, see arrows F and G, and will not populate the providers data 18 with data of an approved device (device approval data 26) as shown by arrow I.

In one preferred embodiment, the system provides device alternatives such as a menu or formulary of approved devices.

In one embodiment, device approval data 26 is the preferred result/information of the medical device management approval system 10 favorably matching system elements including but not limited to: patient data 12, payer requirement data 14, procedure pre-approval data 16, provider data 18, device data 20, vendor data 22, outcome data 30, and facility data 24.

An alternative embodiment of the invention is when the above elements do not match and device approval 26 does not occur (e.g., denial). The device approval data 26 can include data for when approval is not obtained.

A major advantage of the system 10 is that physician device preference can be guided by appropriate indications based on clinical guidelines increasing patient satisfaction. Another major advantage of the system 10 is to function as a gain-sharing program wherein hospitals can reduce implant price and/or control implant selection to provide gain-sharing opportunities to providers.

As described herein, a provider is any person or entity selecting a device for a patient, and involved with the use of the device on the patient.

In one embodiment, the medical service management approval system 100 can be operated similarly as described herein in connection with the medical device management approval system 10, or both systems can be operated together (e.g., include the same system components) when a medical procedure includes both a service and a device or any product. Here, the service approval data 21 can be used in addition to or in place of the device approval data 26, and obtain in the same way but using services in place of device. The service data 23 can be used in addition to or in place of the device data 20, where the service data 23 includes information about the medical service to be performed. The service provider data 25 can be used in place of the vendor data 22 or may be related to the provider data 18 but with an emphasis on the service. The facility service data 27 may be used in place of or in addition to the facility data 24, but with an emphasis on the service that is provided at the facility.

In one embodiment, the provider data can include an electronic preference card, which can be a module or database (e.g., selected portion of database). The electronic preference card can include the preferences of the provider with regard to services and/or devices to be used for a defined condition. The electronic preference card can be used to modify and distribute a provider's data with updates and changes as their practice evolves. The provider electronic preference card may be part of the provider data 18. The electronic preference card can be a graphical representation of the materials needed for a medical procedure including the approved device selected for the procedure. The system preferably populates the provider's electronic preference card after a device approval as show by arrow I in FIG. 3 (e.g., or service approval). The electronic preference card is then distributed to those involved with the procedure including the vendor and operating room staff for setting up an operating room for a surgery or other medical procedure. In one aspect, the system will not populate the provider's electronic preference card with a device if the system has not approved the device. Alternatively, the system can populate the card with another device or list of other devices that the system has matched with a patient data, such as for a particular procedure.

In one embodiment, the medical management system is configured to include and manage and operate with a medical device management database. The medical device management database can include medical data that can facilitate the methods described herein. The medical data can include: patient data, payer data (e.g., insurance), payer requirement data (e.g., any data of requirements of payer to make payment and/or an approval), payment requirement data (e.g., payment data, requirement data, insurance plan data, etc.), provider data (e.g., hospital data, doctor data, surgeon data, medical facility data, medical support staff data, etc.), vendor data (e.g., medical device provider, distributor, and/or manufacturer, etc.), device data (e.g., cost data, use data, compliance data, device recall data, device performance data, etc.), device contracted price data (e.g., data regarding costs of a device in a contract, etc.), device actual price data (e.g., data regarding the actual price from seller or to buyer), and/or facility data (e.g., any data related to facility requirements, permissions, etc.). In one aspect, the system can be configured to compare the different types of data (e.g., compare patient data with payer requirement data and provider data to meet criteria in order to return an approval for the device. As such, at least three different types of data can be compared in order to obtain an approval for use of a medical device.

In one aspect, the medical device management system can compare at least three different types of data for approval of a medical device. For example, the at least three different types of data that are compared can include: patient data, payer data, payer requirement data, provider data, vendor data, device data, device contracted price data, device actual price data, and/or facility data, and/or outcome data. In one aspect, the system is configured to compare patient data with device data and surgeon's preference data (e.g., provider data) in order to return an approval. In one aspect, the system is configured to compare facility data with provider data and device contracted price data in order to return an approval. In one aspect, the system is configured to compare device data with device contracted price data and device actual price data in order to determine if there is a price difference between contracted price and actual price, and to also compare the price difference to a surgeon's preference data (e.g., provider data) to return an approval. In one aspect, the system is configured to compare patient data with payer requirement data and provider data in order to return an approval. In one aspect, the system is configured to compare patient data with device data and provider data in order to return an approval. In one aspect, the system is configured to compare facility data with provider data and device price data (e.g., contracted or actual) in order to return an approval. In one aspect, the system is configured to compare device contracted price data to device actual price data in order to determine a price difference, and then compare the price difference to provider data or facility data in order to return an approval.

In accordance with the invention, the medical device management system can perform a method to manage medical devices to facilitate a facility or payer's approval for use of the devices in medical services.

In one embodiment, the system can have a medical database with all of the data described herein, or each type of data can be in its own database. Accordingly, reference to acquisition of data from a database can refer to the system acquiring the data from any relevant database, whether general medical database or specific medical database.

In one embodiment, a medical device management method can include the following steps. The method may include operation of a computing system (desktop, laptop, mobile, or otherwise) to perform the method steps outlined to implement the medical device management method. The method may be initiated with a medical person (e.g., doctor, surgeon, nurse, technician, medical assistant, medical office person, scheduler, medical record person, etc.) inputting instructions that cause the system to determine whether a medical device is approved. The system can access a database having the following data: patient data, authorization number, payer data (e.g., insurance), payer requirement data (e.g., any data of requirements of payer to make and approval and/or payment), payment requirement data (e.g., payment data, requirement data, insurance plan data, etc.), provider data (e.g., hospital data, doctor data, surgeon data, medical facility data, medical support staff data, etc.), vendor data (e.g., medical device provider, distributor, and/or manufacturer, etc.), device data (e.g., cost data, use data, compliance data, etc.), device contracted price data (e.g., data regarding costs of a device in a contract, etc.), device actual price data (e.g., data regarding the actual price from seller or to buyer), and/or facility data (e.g., any data related to facility requirements, permissions, etc.). The system can extract at least three different types of data from the database, which data can be any described herein. The system can then compare at least two types of data (or at least three types of data) to obtain a comparative result. The system can then compare the comparative result to approval criteria (or criterion if singular). If the comparative results are at or above an approval threshold value, then the medical device is approved for use in a medical service. If the comparative results are below the approval threshold value, then the medical device is not approved (e.g., denied) for use in a medical service. The approval or denial is then saved in a database, such as the medical database for acquisition at some time point. The approval or denial data can be linked with any of the data used in order to make the comparison, and may also be linked with the particular patient, payer, provider, vendor, device, and/or facility.

The performance of the medical device management method can include comparing patient data with payer requirements and provider data to return an approval. In one aspect, the method can include comparing patient data with device data and provider data to return an approval. In one aspect, the method can include comparing facility data with provider data and device price data (e.g., contracted or actual) to return an approval. In one aspect, the method can include analyzing device data by comparing device contracted price data to device actual price data, and determining the difference therebetween, and then comparing the difference to provider data or facility data to return an approval.

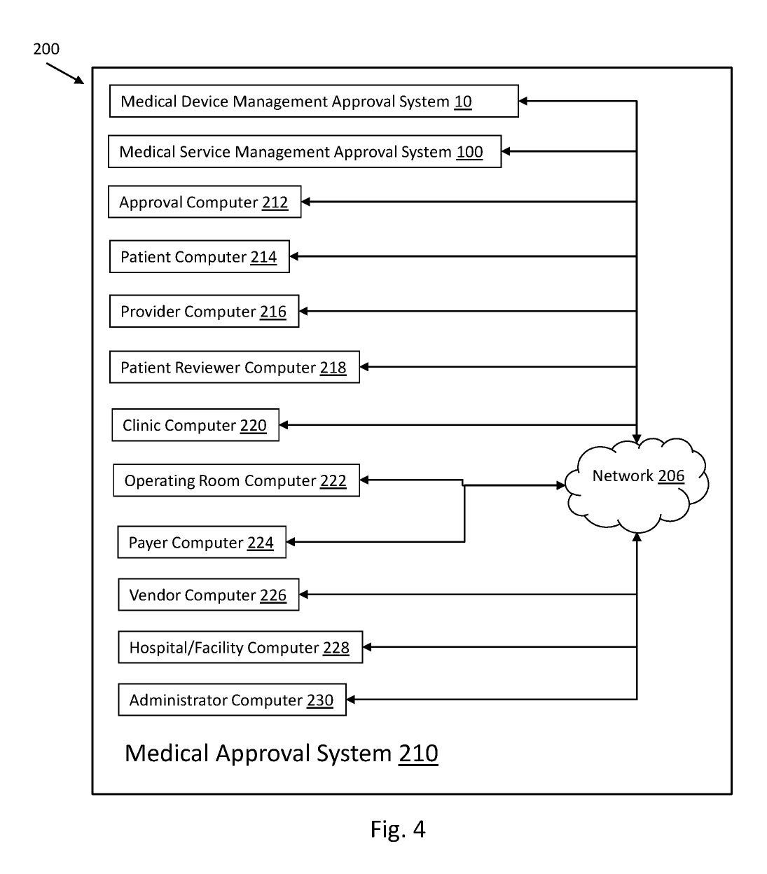

FIG. 4 shows a hospital system 200 that can operate with the systems 10, 100 described herein. Here, the medical approval system 210 can include the components of the systems 10, 100. The medical approval system 210 can include an approval computer 212 that includes the software for performing the medical approvals of systems 10, 100, which is connected to the hospital network 206 (e.g., via WiFi, Bluetooth, optical fiber, or other), where the hospital network 206 can include any type of data communications network, such as a local network, intranet, or internet, and may be distributed over one or more hospitals or hospital systems 200. The medical approval system 210 can include a patient computer 214 (e.g., handheld, tablet, smart phone, etc.) or a provider mobile device (e.g., provider computer 216), a vender mobile device (e.g., vendor computer 226), hospital/facility computer 228 (e.g., a mobile device), administrator computer 230 (e.g., hospital administrator mobile device), or others that can communicate through the network 206 with the approval computer 212, where the approval computer 212 can receive input (e.g., insurance information, ailments, or patient data 12, etc.) from the patient computer 214 and provide information (e.g., approval, denial, insurance instructions, etc.) back to the patient computer 214. The medical approval system 210 may also include a provider computer 216 (e.g., handheld, tablet, smart phone, laptop, etc.) that can communicate through the network 206 with the approval computer 212, where the approval computer 212 can receive input (e.g., medical service data 23, device data 20, patient data 12, payer data 13, provider data 18, electronic preference card, etc.) from the provider computer 216 or provide information (e.g., approval, denial, insurance instructions, etc.) back to the provider computer 216. The system 200 is operable by any person or entity including but not limited to a medical reviewer for the payer, a quality assurance person of the facility, utilization review personal and/or consultants.

Other computer systems may be included, such as a patient reviewer computer 218 (e.g., or portal to system), which reviews patent data 12 and provides information to the provider computer 216 and/or approval computer 212, which can be operated automatically by software or under control of a person. However, this may be a part of the approval computer 212 or aspect of the system 210. A clinic computer 220 located in a medical clinic may be operably coupled with the medical approval computer 212 and/or provider computer 216 to provide information about the patient (e.g., patient data 12), payer (e.g., payer data 13), or provider (e.g., provider data 18) to the approval computer 212, such as via the network 206. Clinic personnel can operate the clinic computer 220 and provide instructions for communications within the medical approval system. An operating room computer 222 may also be in communication with the approval computer 212 via the network 206, which can be located in an operating room and operated by a medical professional (e.g., doctor, surgeon, physician assistant, nurse, technician, orderly, etc.) in order to provide data to get approval and/or receive information about the approval or denial of a service or a device, or changes to any data related to the procedure (e.g., change in service and/or device or implantation (instruments) system intra operatively). In some instances, a payer may have a payer computer 224 that provides payer data 13 to the approval computer 212, as well as makes changes thereto and provides updates, which can be operated automatically or by a person, which may be remote or offsite from the hospital. The vendor may also have a vendor computer 226 that provides vendor data 22 to the medical approval system 210 via the network 206, which may be autonomous or operated by a person. While an embodiment of the medical approval system 210 is illustrated, changes or modifications may be made so long as it can still provide approval or denial for services and/or devices.

In one embodiment, the provider inputs data into the medical approval system 210 in order to get approval for a service and/or device. Once the data is input, the provider clicks an icon, or taps on a screen, on a display of the provider computer 216, such as a single click, or such as a single touch, and then the medical approval system 210 accesses the approval computer 212, and either an approval or denial is automatically provided back to the provider computer 216. As such, once information is input, the approval or denial can be obtained with a “single click”, or a “single touch”, or single electronic request. The medical approval system 210 compares the entered data to the requirements that need to be met in order for an approval to be made. If all of the entered data matches and fulfills the requirements, then approval is made. If any single requirement is not met by the entered data, a denial is made. Optionally, the system can indicate (e.g., highlight) the data element that did not match or fulfill the requirement, and then the data can be re-entered, such as for only the data elements that resulted in the denial, and resent for approval. If the new request is satisfactory to overcome the reasons of the denial, then approval can be obtained.

The present systems and methods overcome complications and hassles in the medical/surgical arena. One problem that is overcome is that a physician examines a patient that has a medical problem, and then has to match the patient's physical ailment, medical history, and other certain criteria that are required for authorization of a medical procedure. For example, if the patient has an arthritic knee, the patient may be required to have loss of certain activities or loss percentage of daily living that is on a graded scale (e.g., 1 to 10, with 1 being no loss and 10 being extreme loss). Also, the patient may be required to have failed to get better with conservative care for a defined period of time. Additionally, the physician may be required to provide imaging to support the diagnosis or recommendation for the medical procedure. The doctor then has to diagnose the ailment and prescribe a medical service and/or device to correct the ailment. In order to perform the service and/or use the device, the physician has to submit all of the relevant information to the insurance company, and/or the facility, and the insurance company and/or the facility has to review that information, which can be in the form of the dictated history, physical, medical, or other information in an electronic medical record or hard copy (e.g., currently by fax). The insurance company has to sort through that information for certain criteria to allow for approval or denial of the procedure. However, a lot of criteria can be missed, or physicians are unaware of the criteria required for each insurance plan, and then moreover each plan has different sub-plans (e.g., gold, platinum, blue, select, etc.). If anything is missing, a denial can be generated by the insurance company, when in actuality it should have been an approval based on the real data.

Now, however, the present invented approval system receives the input from the provider, pulls up the patient's insurance information, and finds out what the insurance criteria is for a diagnosis, and then matches the criteria with the provider input. When the provider input matches the criteria, then approval for a procedure to treat the diagnosis can be obtained. In one aspect, the provider has the insurance criteria for a diagnosis and/or treatment on their computer, and then makes selections in order to completely comply with the insurance criteria. This helps avoid false denials. Avoiding and/or correcting false denials reduces the need for payers to pay medical reviewers for time consuming and expensive “Peer to Peer” conversations between the provider and the medical reviewer working for the payer (or another person or entity acting on behalf of the provider or the payer). One aspect of the invention is to reduce the cost of health care by saving payers, facilities, providers and physicians time, improving productivity, and reducing overhead costs by providing fast transparency into what is currently required (guidelines and costs) to treat a patient (member) in one or different locations. Accordingly, the system can have the criteria for an insurance and sub plan for a patient, and then make inputs into their computer, which inputs are provided (e.g., one click, or tap, or touch) to the approval computer, that then processes the data, and provides an approval (or denial). Here, approvals can be increased and false denials can be reduced immediately at the point of care. The medical approval system may include a database with the criteria (e.g., payer requirement data).

In one embodiment, a patient can sit with the provider with the provider computer, and review the patient's insurance plan and criteria for a diagnosis tied to a procedure. The patient and provider can go through the criteria displayed on the computer screen for the patient's diagnosis tied to a procedure. For example, a list can be presented so that criteria can be selected, such as in a checklist or bubble selection or other selection format. Then, the provider can go through the checklist and make the proper selections of criteria for the diagnosis in order to get approval for the procedure. For example, on a handheld computer the provider can click all the criteria, click submit (e.g., one click) and get automatic approval for the procedure (e.g., service and/or device). If one of the criteria is missing, the medical approval system will bring up an alert—automatically, which may be within a few seconds to a few minutes while the patient is still present. If a denial alert is received, the checklist can be reviewed and corrected if needed in order to get approval. In other instances, based on the diagnosis, another or different procedure can be approved, and the medical approval system can provide that alternative procedure to the patient and provider to review to see if it is suitable. Otherwise, the provider and/or patient can contact the insurance provided to get an exception to the denial, in order to get approval for the desired procedure.

In one aspect, missing criteria can be highlighted or otherwise called out so that the patient and/or provider can assess the criteria to determine where it fits with the patient's diagnosis. For example, a physician would like to schedule a patient's surgery for next Tuesday and the information is entered into the medical approval system; however, the patient has only had 4 weeks of physical therapy, but the insurance requires 6 weeks of physical therapy. The alert is provided to the provider's computer from the approval computer, with an indication that 2 more weeks of physical therapy are required to cover the medical procedure. The physician and patient agree to meet again in 2 weeks once a full 6 weeks of physical therapy is performed. Then, they enter in the criteria for the procedure and schedule the surgery with automatic approval upon entry or completion of the criteria into the medical approval system. The automatic approval or denial of coverage for a procedure can improve communication between the provider and the patient, and allows for knowledge of the reason of denial so that the reason can be rectified to gain approval. Automatic approvals (or pre-approvals) reduces phone calls from patients to providers, from providers to payers, and to and from facilities, for unexplained denials and/or long waits (days and weeks) until an approval decision is made.

In one embodiment, a unique “thumbs up” icon is provided with or without a unique audible alert (e.g., sounds happy or positive, like increasing note scale, higher pitched, etc.) to provide approval. In one aspect, a unique “thumbs down” icon is provided with or without a unique audible alert (e.g., sounds sad or negative, like declining note scale or lower pitched, etc.) Flashing green lights can be an approval, where flashing red lights can be a denial. Approval provides an authorization number for the provider and to the medical approval system, which is updated in the database. In another aspect, a glowing brain icon or hourglass icon is provided to indicate a pending decision. In another aspect, navigation is performed with plurality of neuron icons synapsing with another neurons in series, in parallel, or in branches illuminating (or changing color, or shape) to indicate where the operator is within the system.

Once approval, or pre-approval, is received from the payer, then approval is requested from the facility. That is, the medical approval system can provide the approval for the procedure for the patient via the insurance, but then the provider has to get approval from the facility to use the facility to perform the procedure (e.g., service and/or device). The facility can approve the provider to perform the procedure before the procedure can be performed.

The facility can access the provider data to see what credentials and privileges the provider has at the facility, and the credentials and privileges for the provider are matched with the requirements of the facility for the procedure (e.g., service and/or device). In one example, the medical approval system 210 provides a menu to the display of the provider computer for review and selection of criteria, and the provider selects the appropriate criteria that is then analyzed by the approval computer. In one option, the provider inputs the desired service and/or device, but in other options, the facility provides a menu of services and/or devices (e.g., types of devices, levels of quality, vendors, etc.) that are approved for use at the facility.

In one aspect, a patient may only qualify for a “C” level device. However, the patient and provider want to implant an “A” level device. Once the patient data is entered and analyzed by the medical approval system (e.g., approval computer), the system may deny the “A” level device, but approve the “C” level device, which may be based on insurance data and/or patient data. Often, the “A” level is a premium device, where the “C” level or other lower levels are of lesser (or different) quality (e.g., porous coated versus non porous coated, plastic verses metal, etc). For example, if the patient is over 75 years old, a non-porous coated hip stem is selected, as the patient will not benefit from the more expensive porous stem, because of their age (e.g., they are less likely to grow new bone).

In one aspect, the facility does a cost analysis on the procedure (e.g., service and/or device) and makes a comparison with the fees for the procedure (e.g., service and/or device fees) and expenditures (e.g., operating room and staff costs, provider costs, etc.). If the comparison results in a profit for the facility, then approval can be provided. If the comparison results in a loss for the facility then a denial can be provided. However, the system may automatically make changes to similar services and/or devices and redo the comparisons and calculations until a procedure (e.g., service and/or device) is determined to provide a profit. As such, either approval, denial, or amendment with approval can be provided to the provider (e.g., to provider computer). In one instance, bundle payment programs are analyzed to determine approval or denial. In another instance providers, and or facilities are analyzed in order to determine rewards. The rewards can be attributed to the provider when the provider performs the procedure with the service and/or device and comes under budget so that there is a profit for the facility, and/or the patient has a positive outcome so as to be improved after the procedure. The rewards can be positive when profit and positive patient outcome, or negative when the procedure comes in at a loss of profit and/or the patent has a negative outcome and is either not improved or worsened after the procedure.

In one embodiment, if the facility turns a profit on the procedure (e.g., saves on expenses with more revenue), then the profit can be tracked for the provider as well as for the service, device, and optionally to the patient. The tracked profits can be used to increase the privileges or authorizations for the provider. As such, over time by good practice the provider can increase their privileges or authorizations at the facility when they generate a profit. In one example the profits, privileges or authorizations are tracked in the electronic provider card (e.g., electronic preference card), which can be similar to a status card, progress card, or report card. This allows a provider to get rewards (e.g., increased reward number) by being profitable. An aspect of the system is tracking profits and losses providing transparency to the cost and benefit, or value of healthcare. As described herein; Value=Benefit/Cost. As such, the value to the facility can be the benefit (e.g., profit and/or patient outcome) divided by the cost of the procedure. The patient outcome can be quantified as described herein, such as with a ranking of improvement or worsening (e.g., satisfaction scale) as a result of the procedure. The patient benefit can also be quantified by determining whether a patient's condition is better (e.g., plus (+) 1), worst (e.g., minus (−) 1), or unchanged (e.g., 0).

In one embodiment, the provider has the electronic preference card. Each time the provider orders a specific device the system is going to give an outcome, and the system will track how the patient does with that device, as part of the rewards system, and then the system will be able to determine whether that device is having a good outcome for that patient. One way of determining a benefit of how a patient does with a device and/or service is to determine whether the patient was able to be discharged home for recovery, with or without home health care, or to an expensive rehabilitation facility, skilled nursing facility, or long term care, within a certain time range of 1 day until lifetime. Another way of tracking the benefit of how a patient does with a device and/or service is to determine whether the patient gets readmitted for the same diagnosis or related diagnosis within a certain time range of 1 day until lifetime. Yet another way of tracking how a patient does with a device and/or service is to determine if a service needs to be re-performed or if the device has to be removed or revised. Yet another way of tracking how a patient does with a device and/or service is to determine if they returned to work, to school, took less medications, had less pain and impairment, and/or was satisfied. Any time period can be used and any satisfaction scale (1-10) or quality measure can be used to determine the outcome of a service or a device. The patient benefit can also be quantified by determining whether a patient's condition is better (e.g., plus (+) 1), worst (e.g., minus (−)1), or unchanged (e.g., 0).

In one embodiment, payers (e.g., insurance or government insurance or other company) can be directed to pay hospitals based on the level (e.g., good, medium, bad, 1-10, number of stars, happy or neutral or sad face icon, thumbs up or down or sideways icon, etc.) of outcome for a procedure. The payer will determine an outcome of level “A” for a procedure and then pay at the “A” level, if there is a “B” outcome, they will pay the “B” level, which is less than the “A” level. Thus, there can be a hierarchical outcome for a procedure which is matched with the level payment, which can go from “A” to “Z” if necessary. In one aspect, when below a predetermined outcome threshold, the provider may be denied from doing the type of procedure at the facility, at least until they can increase their level to improve their profits, privileges, or authorizations.

In another embodiment, the system functions as an electronic proctor or electronic privilege system. The provider selects an avatar and starts at level 1 performing level 1 medical services. After successfully performing a predetermined number of level 1 services, the provider moves to level 2 where procedures are approved. After successfully performing a predetermined number of level 2 procedures, the provider moves to level 3, etc. Upon completion of each level the provider receives a reward by moving to the next level and performing increasingly complex, and more expensive procedures. Likewise rewards can be tiered. For example but not limitation, The level 1 procedure will be relatively safe and inexpensive like office visits, consults, or injections compared to the level 2 procedure of performing minor surgery in an outpatient surgery center. Likewise, level 3 can comprise inserting implants and devices in a hospital operating room, level 4; performing deformity surgery, level 5; inserting newly approved devices, and at level 6 the system approves experimental and investigational procedures, etc. Providers can lose a level if their performance is below an acceptable standard. Other provider rewards include preferred block operating time or the facility purchasing new equipment, etc. Penalties can be given to providers for late starts, going overtime, or aborting procedures.

In one embodiment, once a provider gets service and/or device approval, it goes to their electronic preference card. If the provider does not get a device approval, possibly with a patient that comes in with an abnormal anatomy, the provider can enter information into the approval system regarding the abnormal anatomy that may require a special service and/or device. Then on a case-by-case basis abnormal requests can be reviewed if requested. For example, requesting a special devices that is not on the menu, then the system (e.g., from provider computer via system) will send an email to the medical director and they will review the request on a case-by-case basis for an exception. This allows for avoidance of a complete denial in abnormal circumstances.

In one embodiment, the system allows for amendments to the services and/or devices in real time before or during the procedure. Normally, the procedure is predetermined and approved before being scheduled and performed. However, the vendor and/or provider may recognize that another service and/or device may be better for the current condition, and to allow a change, the system can include the provider device having the option to make a change to the previously selected services and/or devices, and then upon submission (e.g., one click, or one touch), the system (e.g., approval computer) can go through the determinations and either automatically approve or deny the amendment to the procedure. For example, it may be recognized that another implant or implantation system may be better for the patient than previously thought, and in real time the provider can get an updated or amended approval before using the different implant or implantation system. When the new devices cost more, the profits for the facility can be calculated to determine approval or denial. Optionally, the new devices may be paid for by the payer, and the system can get approval and provide it to the facility so that the new costs are computed to determine profitability for the approval or denial.

It should be recognized that another computer, such as an operating computer, clinic computer, nurse computer, vendor computer, or other could be used in place of the provider computer in order to interact with the system to get the approvals or denials, as well as implement the amendments. Also, the patient may be able to enter information into the patient computer so that the patient computer can supplement or replace the provider computer.

In one embodiment, a medical service has been approved with an approved medical device—medical device A implanted with medical device B. During the medical service, an entity, such as a vendor indicates that medical device Z is better in this scenario than medical device A, and that using medical device Y to install medical device A or medical device Z is better than using medical device B. In this scenario, the provider (or other medical professional), can bring up the approval of the service and device, and then enter an amendment to replace medical device A with medical device Z, and replace medical device B with medical device Y, which is then submitted to the medical approval system. The medical approval system can then compare costs of the change in medical devices to the approved fee to be paid by the payer, and may also determine if such a substitution of medical devices can result in an increase in the fee paid by the payer. Additionally, approval for the provider to use the medical device Z and/or medical device Y may be analyzed in the provider's authorizations and permissions at the facility. After performing the data analysis, approval or denial can be automatically obtained in real time during the performance of the procedure. This allows the medical service and/or medical device to be amended in real time during a procedure.

In one embodiment, the system can provide a website or application with electronic pages for navigation and data entry for a service or device approval. The electronic pages can include the following as described herein. A physician home page, which can be accessed by the physician can include: amount of money saved at the facility; the rank of savings amongst other physicians; a ranking comparison with optimal care; a budgeted cost; an actual cost; an indication of number of procedures; an icon for selection that shows the number of cases for the physician; an icon for selection that shows the devices that have been used by the physician; and the physician's profile. Also, an icon for adding new patients/cases is selectable.

A physician case list page can include a listing of cases/patients for the physicians with icons for selection to view specific information for the cases/patients. The cases/patients can be ordered in open cases/patients that are currently active, pending cases/patients waiting for approval, and approved cases/patients waiting to become active (e.g., once procedure scheduled or performed, etc.).

A physician case detail page can include the patent medical information (or icon to select to get this information), payer information (or icon to select to get this information), and facility information (or icon to select to get this information). Also, it can include selections for whether the procedure is routing, data sensitive (e.g., before a certain date), or urgent. Various information about the patient, provider, or procedure can also be provided.

A physician notes page can include a history of notes (e.g., chart notes) for a patient with the date of entry, and a form for entering new notes. An icon can be selected to allow the provider to dictate the notes to text. Another icon can be provided to save, delete, print, email, fax, or text a secure medical record of the patient-provider visit.

A pre-authorization page can include the diagnosis codes (searchable or fillable form for entry thereof) and CPT/HCPCS codes (searchable or fillable form for entry thereof). A selectable icon can be present to select in order to enter the payer information. A “submit” selectable icon can be present to select to start the automatic (e.g., one click, or one tap) approval process.

A payer information page can include the patent and relative information (e.g., EMR number, case number, service number, date of birth, first diagnosis date, first and last provider visit dates, and status of procedure. It can also include the payer information and details regarding payment. Selectable diagnosis codes may be present, searched, or icons to select to enter this information. Selectable CPT codes, which can be related to the procedure, may also be present. A search form for diagnosis codes or CPT codes may also be present.

A payer requirements page can include a listing of requirements that need to be met before approval is provided for the procedure, which can include selectable icons to show whether the requirement has been met. Also, the patent information (e.g., same as payer information page) may be present or obtained by clicking an icon. The spinal levels or right side, left side, or bilateral may also be present.

A submit payer information page may include selectable icons regarding DME items, being rental or purchase. Also, the type of service (E.g., outpatient, inpatient, office visit, surgery center, Skilled Nursing Facility, home, home health care, physical therapy, or other) can be present as selectable icons. Likewise, an icon or other graphical element can be selected to illustrate parts of a procedure or construct. Also a provider can electronically mark, draw, or otherwise diagram parts of a procedure or surgical construct illustrating at least a portion of a service or device. Likewise, the user can assemble a menu of devices and build a unique service and/or implant system. The page can provide an icon to insert an image (X-ray, MRI, ultrasound, photograph, etc.). This page may also include a selectable icon for submission for pre-authorization for the procedure. Upon submission, a page showing that the pre-authorization is pending for the procedure for the patient can be generated and provided.

A pre-authorization confirmation page may be provided once pre-approval is determined. This page can include the pre-authorization number for the procedure for the patient, by the provider, and the relevant information. This page may also include a deadline before which the procedure must be completed. This page may also include a visible checkmark to mark approval. This page may also include a selectable icon to go to a page to select the one or more medical devices to use in the procedure, which can go to a vendor page. Optionally, a pre-authorization cost the payer will pay may also be included. Otherwise, a denial page may be generated that denies the approval, and may list the reasons for the denial so that they may be corrected. Likewise, an icon or other graphical element can be selected or drawn to illustrate parts of a procedure or construct. The user can build their unique service and/or implant system from pre-approved parts.

A vendor list page can include a budgeted cost (e.g., pre-authorization cost the payer will pay), vendor cost, and cost variance. The vendor cost can be populated once a device is selected. The vendor list page can include a list of vendors that have devices for the procedure, which can be selectable icons to get information about the specific medical devices.

A vendor detail page can include the maker and medical devices that can be selected for that maker. Each maker can have their own vendor detail page, which can be accessed from the vendor list page. The vendor detail page lists the medical devices for the procedure, and may include contract numbers for selection. Once selected, the vendor cost can be populated and the cost variance determined (e.g., budgeted cost minus vendor cost equals cost variance). A clickable icon for submission of the specific medical device (or medical device system) is provided to select the medical device. Likewise, an icon or other graphical element can be selected or drawn to illustrate parts of a procedure or construct. The user can build a unique service and/or implant system from pre-approved parts.

Also, a system selection page may include selections for implants, instruments, and biologics as well as other medical devices for the procedure, each with a listing with associated costs that when selected populate the vendor cost an update the cost variance. This page may include the provider's preferred systems, vendor recommended systems, and facility preferred systems. This page may also have a submit icon for selection.

In some instances, different implants may be used in a procedure. As such, an implant selection page can be provided that lists the provider's preferred systems, systems comparable to the preferred systems, and a listing of other vendors with systems for the procedure. This page may also have a submit icon for selection.

In some instances, different biologics or delivery systems may be used in a procedure. As such, a biologics selection page can be provided that lists the provider's preferred systems, systems comparable to the preferred systems, and a listing of other vendors with systems for the procedure. This page may also have a submit icon for selection.

Once the submission for the medical device is entered, either a vendor approval page is generated or a vendor denial page is generated.

The vendor approval page can provide an indication that the procedure and medical device are approved. This page may include a “thumbs up” or other icon to indicate approval such as “you have been approved.” The patient, procedure, payer, and medical device may also be provided, along with any contract numbers. Also, a selectable icon for scheduling the procedure (e.g., surgery) may also be presented for selection. The vendor denial page may include a “thumbs down” or “you have been denied” as well as the reasons for the denial, which allows for an amendment to the request and resubmission for approval.

A surgery approval page can include the information of the vendor page with a listing of the patient, procedure, case number, payer information, and medical device system to be used in the procedure. Also, a selectable icon for scheduling the procedure (e.g., surgery) may also be presented for selection.

In some instances a new system may not show up on any of the pages for selection. Accordingly, a request new system page may be available to allow a provider, vendor, or facility to add a new system to the selections. The page may include a field to select or enter a vendor, a field to select or enter a product (e.g., medical device) with or without product number. Also, the page can include a field to allow correlation of this new system with another system in the catalogue for use in particular procedures. The page may also include selections as to whether this new system will be used once, case by case, or recurring. Also, the system can be designated as being used in a procedure that is routine, date sensitive, or urgent. This page may also have a submit icon.

All of the pages can include navigational icons to go between pages as well as a menu (e.g., drop down) to provide navigation between pages.

In one embodiment, a method for managing medical device approval can include the following steps. The medical approval system can receive a request to approve a medical device, such as from a patient, provider, or facility. Then, the system can obtain at least three data sets for analysis, where the data sets may be in one or more databases. The databases may be in the system, and by obtaining the system accesses the data. The data can be from the following data sets: patient data for a patient to receive the medical device; payer requirement data for a payer that pays for the medical device; provider data for a provider that uses the medical device on the patient; vendor data for a vendor for the medical device; device data for the medical device; device contracted price data for the medical device; device actual price data for the medical device; and facility data for a facility where the provider uses the medical device on the patient. The system can then upon a request or automatically, compare the at least three data sets to determine if the medical device matches with the at least three data sets. By matching, it is meant that the device is approved for an indication for the patent, the payer will pay for the device upon meeting certain requirements, the provider is authorized to use the medical device, the vendor is authorized to provide the device to the provider and facility, the device is certified to be used for the indication in the patent to treat the patent, and the facility can authorize use of the device on the patient if certain criteria are met. In many instances, there are levels of comparison for the device. A primary level can include information relevant to whether the device matches the needed treatment of the patent, whether the provider has used the device, and whether the facility allows use of the device. If the device does not match the indication for that patient, then it is denied. A secondary level can include an analysis of matching device costs with the amount the payer will pay, the amount the provider will get paid to use the device, and the amount the facility will be paid or need to be paid for profitability. If not profitable, it is denied. The system determines whether or not the medical device is approved, which is based on the comparisons with the device as described. If the at least three data sets match with the medical device, the medical device is approved. Alternatively, if the at least three data sets do not match with the medical device (e.g., if any one does not match the others), the medical device is not approved (denied). When the at least three data sets do not match it can be because only one, two or all three do not match. Any time one data set does not match, then the at least three do not match. All three matching is required in one embodiment for approval, and any one of the three not matching can cause denial. However, there may be instances where only two need to match instead of three for the approval.

In one aspect, the method can include comparing patient data, payer requirement data, and provider data to determine if the medical device matches with these three data sets. In one aspect, the method can include comparing patient data, device data, and provider data to determine if the medical device matches with these three data sets. In one aspect, the method can include comparing facility data, provider data, and device data, wherein device data includes device price, to determine if the medical device matches with these three data sets.

In one embodiment, the method can include determining a difference between device contracted price with device actual price to determine which is greater; and comparing the greater of the device contracted price or device actual price with the facility data, wherein the facility data includes amount to be paid to the facility from the payer for the medical device. If the amount to be paid to the facility for the medical device is more than the greater of the actual price or contracted price, then the medical device is approved. Alternatively, if the amount to be paid to the facility for the medical device is less than the greater of the actual price or contracted price, then the medical device is not approved.

In one embodiment, a computer system for management of medical device approval can include computer-executable instructions stored on a non-transient storage media that when executed cause the computer system to perform the method. In one aspect, the computer system can compare patient data, payer requirement data, and provider data to determine if the medical device matches with these three data sets. In one aspect, the computer system can compare patent data, device data, and provider data to determine if the medical device matches with these three data sets. In one aspect, the computer system can compare facility data, provider data, and device data, wherein device data includes device price, to determine if the medical device matches with these three data sets.

In one embodiment, the computer system can be configured (programmed) for: determining a difference between device contracted price with device actual price to determine which is greater, and comparing the greater of the device contracted price or device actual price with the facility data, wherein the facility data includes an amount to be paid to the facility from the payer for the medical device. If the amount to be paid to the facility for the medical device is more than the greater of the actual price or contracted price, then the medical device is approved. Alternatively, if the amount to be paid to the facility for the medical device is less than the greater of the actual price or contracted price, then the medical device is not approved.

In one embodiment, a method for managing medical service approval can include the following steps: receiving a request to approve a medical service; obtaining at least three data sets from the following data sets: patient data for a patient to receive the medical service; payer requirement data for a payer that pays for the medical service; provider data for a provider that performs the medical service on the patient; service data for the medical service; service price data for the medical service; and facility data for a facility where the provider performs the medical service on the patient; comparing the at least three data sets to determine if the medical service matches with the at least three data sets; and determining whether or not the medical service is approved. If the at least three data sets match with the medical service, the medical service is approved. Alternatively, if the at least three data sets do not match with the medical service (e.g., if any one does not match the others), the medical service is not approved (denied). When the at least three data sets do not match it can be because only one, two or all three do not match. Any time one data set does not match, then the at least three do not match. All three matching is required in one embodiment for approval, and any one of the three not matching can cause denial.

However, there may be instances where only two need to match instead of three for the approval.

In one aspect, the method can include comparing patient data, payer requirement data, and provider data to determine if the medical service matches with these three data sets. In one aspect, the method can include comparing patient data, facility data, and provider data to determine if the medical service matches with these three data sets.

In one embodiment, the method can include comparing the payer requirement data, service price data, and facility data, wherein the service price data includes an amount to be paid to the service provider, wherein the facility data includes an amount to be paid to the facility from the payer for the medical service. If the amount to be paid to the facility from the payer for the medical service is more than the amount to be paid to the service provider and the medical service conforms to the payer requirement data, then the medical service is approved. Alternatively, if the amount to be paid to the facility from the payer for the medical service is less than the amount to be paid to the service provider or the medical service does not conform to the payer requirement data, then the medical service is not approved.

In one embodiment, a computer system for management of medical service approval can include computer-executable instructions stored on a non-transient storage media that when executed cause the computer system to perform the method. In one aspect, the computer system can compare patient data, payer requirement data, and provider data to determine if the medical service matches with these three data sets. In one aspect, the computer system can compare patient data, facility data, and provider data to determine if the medical service matches with these three data sets.

In one embodiment, the computer system can compare the payer requirement data, service price data, and facility data, wherein the service price data includes an amount to be paid to the service provider, wherein the facility data includes an amount to be paid to the facility from the payer for the medical service. If the amount to be paid to the facility from the payer for the medical service is more than the amount to be paid to the service provider and the medical service conforms to the payer requirement data, then the medical service is approved. Alternatively, if the amount to be paid to the facility from the payer for the medical service is less than the amount to be paid to the service provider or the medical service does not conform to the payer requirement data, then the medical service is not approved.

A method of approving a medical service and/or device, the method comprising: entering patient data into a medical approval system, the data including one or more medical conditions of a patient; entering medical service data and/or medical device data into the medical approval system; entering payer data into the medical approval system, wherein the payer data includes data related to requirements for the payer to pay for the medical service and/or medical device; requesting approval of the medical service and/or medical device; and receiving, automatically, an approval or denial of the request. Here, the steps are on the provider side as with the provider computer. However, the steps can be performed on the system side or on the side of the approval computer, which receives the entries and request, and provides the approval or denial. In one aspect, the request includes a single click, or a single touch, in order to receive the approval or denial. That is, once the request is submitted, the approval or denial is automatically generated by the system. In one aspect, a computer system for management of medical approval can include computer-executable instructions stored on a non-transient storage media that when executed cause the computer system to perform the method.

In one embodiment, a method of approving a medical service and/or medical device, can include: providing criteria to be met for approval of a medical service and/or medical device; entering data for the criteria; and requesting approval of the medical service and/or medical device. If all of the criteria are satisfied, approval is provided. Alternatively, if one or more elements of the criteria are not satisfied, denial is provided. In one aspect, if denial is provided criteria related to the denial is provided, then the method comprises: entering data for the criteria related to the denial; and requesting approval of the medical service and/or medical device, then if all of the criteria are satisfied, approval is provided; or if one or more elements of the criteria are not satisfied, denial is provided.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory, but is non-transitory. The computer readable medium is a physical medium having the computer-readable instructions stored therein so as to be physically readable (repeatedly over time when accessed) from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a flash drive, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable” to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

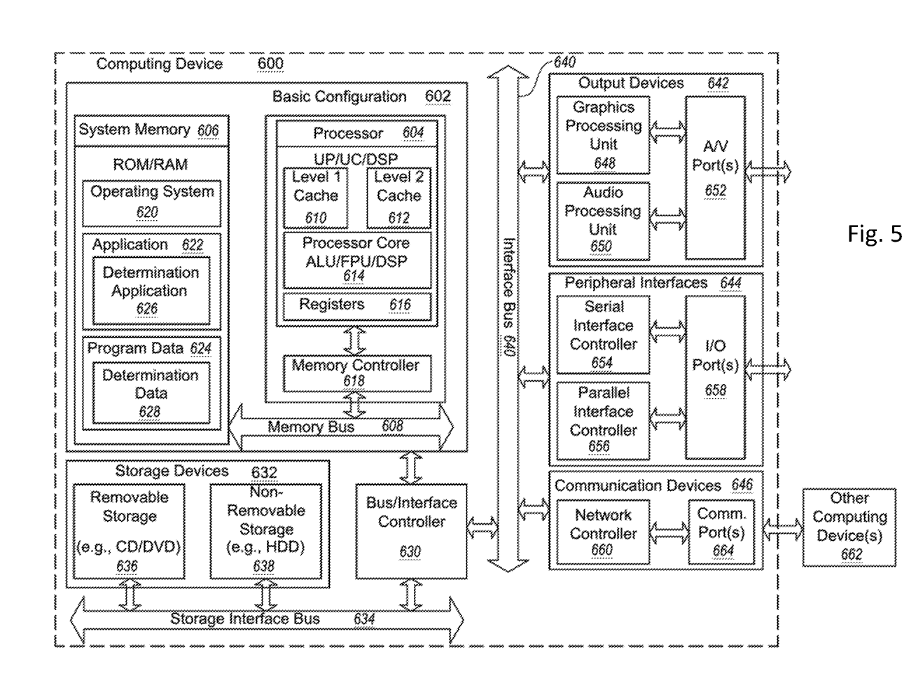

FIG. 5 shows an example computing device 600 (e.g., computer) that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including, but not limited to: volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims), are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited, to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A method for managing medical device approval, the method comprising:
receiving a request to approve a medical device;
obtaining at least three data sets from the following data sets: patient data for a patient to receive the medical device; payer requirement data for a payer that pays for the medical device; provider data for a provider that uses the medical device on the patient; vendor data for a vendor for the medical device; device data for the medical device; device contracted price data for the medical device; device actual price data for the medical device; and facility data for a facility where the provider uses the medical device on the patient;
comparing the at least three data sets to determine if the medical device matches with the at least three data sets; and
determining whether or not the medical device is approved, wherein:
if the at least three data sets match with the medical device, the medical device is approved; or
if at least one of the at least three data sets does not match with the medical device, the medical device is not approved.

2. The method of claim 1, comprising comparing patient data, payer requirement data, and provider data to determine if the medical device matches with these three data sets.

3. The method of claim 1, comprising comparing patient data, device data, and provider data to determine if the medical device matches with these three data sets.

4. The method of claim 1, comprising comparing facility data, provider data, and device data, wherein device data includes device price, to determine if the medical device matches with these three data sets.

5. The method of claim 1, comprising:
determining a difference between device contracted price with device actual price to determine which is greater; and
comparing the greater of the device contracted price or device actual price with the facility data, wherein the facility data includes amount to be paid to the facility from the payer for the medical device, wherein:
if the amount to be paid to the facility for the medical device is more than the greater of the actual price or contracted price, then the medical device is approved; or
if the amount to be paid to the facility for the medical device is less than the greater of the actual price or contracted price, then the medical device is not approved.

6. A computer system for management of medical device approval, comprising computer-executable instructions stored on a non-transient storage media that when executed cause the computer system to perform the method of claim 1.

7. The computer system of claim 6, comprising the computer system comparing patient data, payer requirement data, and provider data to determine if the medical device matches with these three data sets.

8. The computer system of claim 6, comprising the computer system comparing patent data, device data, and provider data to determine if the medical device matches with these three data sets.

9. The computer system of claim 6, comprising the computer system comparing facility data, provider data, and device data, wherein device data includes device price, to determine if the medical device matches with these three data sets.

10. The computer system of claim 6, comprising the computer system:
determining a difference between device contracted price with device actual price to determine which is greater; and
comparing the greater of the device contracted price or device actual price with the facility data, wherein the facility data includes an amount to be paid to the facility from the payer for the medical device, wherein:
if the amount to be paid to the facility for the medical device is more than the greater of the actual price or contracted price, then the medical device is approved; or
if the amount to be paid to the facility for the medical device is less than the greater of the actual price or contracted price, then the medical device is not approved.

11. A method for managing medical service approval, the method comprising:
receiving a request to approve a medical service;
obtaining at least three data sets from the following data sets: patient data for a patient to receive the medical service; payer requirement data for a payer that pays for the medical service; provider data for a provider that performs the medical service on the patient; service data for the medical service; service price data for the medical service; and facility data for a facility where the provider performs the medical service on the patient;
comparing the at least three data sets to determine if the medical service matches with the at least three data sets; and
determining whether or not the medical service is approved, wherein:
if the at least three data sets match with the medical service, the medical service is approved; or
if at least one of the data sets of the at least three data sets does not match with the medical service, the medical service is not approved.

12. The method of claim 11, comprising comparing patient data, payer requirement data, and provider data to determine if the medical service matches with these three data sets.

13. The method of claim 11, comprising comparing patient data, facility data, and provider data to determine if the medical service matches with these three data sets.

14. The method of claim 1, comprising comparing the payer requirement data, service price data, and facility data, wherein the service price data includes an amount to be paid to the service provider, wherein the facility data includes an amount to be paid to the facility from the payer for the medical service, wherein:
if the amount to be paid to the facility from the payer for the medical service is more than the amount to be paid to the service provider and the medical service conforms with the payer requirement data, then the medical service is approved; or
if the amount to be paid to the facility from the payer for the medical service is less than the amount to be paid to the service provider or the medical service does not conform with the payer requirement data, then the medical service is not approved.

15. A computer system for management of medical service approval, comprising computer-executable instructions stored on a non-transient storage media that when executed cause the computer system to perform the method of claim 11.

16. The computer system of claim 15, comprising the computer system comparing patient data, payer requirement data, and provider data to determine if the medical service matches with these three data sets.

17. The computer system of claim 15, comprising the computer system comparing patient data, facility data, and provider data to determine if the medical service matches with these three data sets.

18. The computer system of claim 15, comprising the computer system comparing the payer requirement data, service price data, and facility data, wherein the service price data includes an amount to be paid to the service provider, wherein the facility data includes an amount to be paid to the facility from the payer for the medical service, wherein:
if the amount to be paid to the facility from the payer for the medical service is more than the amount to be paid to the service provider and the medical service conforms with the payer requirement data, then the medical service is approved; or
if the amount to be paid to the facility from the payer for the medical service is less than the amount to be paid to the service provider or the medical service does not conform with the payer requirement data, then the medical service is not approved.

19. A method of approving a medical service and/or device, the method comprising:
entering patient data into a medical approval system, the data including one or more medical conditions of a patient;
entering medical service data and/or medical device data into the medical approval system;
entering payer data into the medical approval system, wherein the payer data includes data related to requirements for the payer to pay for the medical service and/or medical device;
requesting approval of the medical service and/or medical device; and
receiving, automatically, an approval or denial of the request.

20. The method of claim 19, wherein the request includes a single click in order to receive the approval or denial.

21. A computer system for management of medical approval, comprising computer-executable instructions stored on a non-transient storage media that when executed cause the computer system to perform the method of claim 19.

22. The method of claim 1, comprising updating the provider data by determining a reward for the provider, wherein the reward is determined by:
analyzing a financial benefit provided by the provider for performing a procedure and dividing the financial benefit by a cost of the procedure caused by the provider; or
analyzing a benefit of a patient outcome in response to a procedure performed by the provider and dividing the benefit of the patient outcome by a cost of the procedure caused by the provider.

23. The method of claim 11, comprising updating the provider data by determining a reward for the provider, wherein the reward is determined by:
analyzing a financial benefit provided by the provider for performing a service and dividing the financial benefit by a cost of the service caused by the provider; or
analyzing a benefit of a patient outcome in response to a service performed by the provider and dividing the benefit of the patient outcome by a cost of the service caused by the provider.

24. The method of claim 19, wherein the request includes a single touch in order to receive the approval or denial.
